(19) United States
(12) Patent Application Publication
(10) Pub. No.: US 2007/0285400 A1
(43) Pub. Date: Dec. 13, 2007

(54) Palm attached touch-pad computer mouse

(76) Inventor: Sibin Lu, (US)

Correspondence Address: Sibin Lu, 272 Fairway Blvd., Jackson, TN, 38305, US

(21) Appl. No.: 11/482,080

(22) Filed: Jul. 6, 2006

Related U.S. Application Data
(60) Provisional application No. 60/812,562, filed on Jun. 12, 2006.

(51) Int. Cl. G06F 3/041

(52) U.S. Cl. 345/173

(57) ABSTRACT

A palm attached touch-pad computer input mouse that provides both right and left hand use equally with capabilities of both thumb and index finger input and a 360 degree rotational plastic snap close joint with a palm attached base.

The present application claims priority to U.S. provisional application Ser. No. 60/812,562 filed on Jun. 12, 2006.

### FIELD OF THE INVENTION

The present invention relates to the computer mouse, and particularly to a palm-attachable touch-pad mouse adapted for use with traditional personal computers.

### BACKGROUND OF THE INVENTION

The traditional computer mouse is well known and basically consists of a mouse housing, intended to sit on a desk or table in front of its user for use. By reaching forward to this mouse, the user may control the computer from screen to screen by means of a clicking the buttons on top of the mouse. Computer mice come in a wide variety of shapes, sizes and configurations with the most modern models now providing the user with a more comfortable grip on the mouse when in use. Less expensive models have fewer features, however, most contain a right and left side clicking input device to control screen activity of the computer to which it is attached. The general objective of mouse devices is to provide the user a means to control computer screen usage of up and down, side-to-side, highlighting, moving and deleting activities when using the computer. With the advent of the Object-oriented programming, computer software developers have been wooing the icons, menus and buttons to increase the convenience for more friendly human-computer interface, which has brought about the setback of the user's dependence on the computer mouse—the due cause of the Repetitive Strain Injuries because of the fact that a) the user tends to be inertia of one fixed position that slows down the blood flow to wither certain muscles, and b) the repetitive strain of clicking, moving and reaching the mouse device. In order to solve this problem, many attempts have been made to design an easy to use computer mouse, which is ergonomically synchronized with the human form or infrared controlled to allow the user to use less force in mouse button clicking. These attempts, to some extend, have shown some ergonomic effects, but they have generally been unsuccessful because they have not solved the problems of the strain of forceful clicking or the mouse dependence upon a fixed position that results in the strainful distance of mouse-reaching.

While the conventional computer mouse is still in use, some attempts have been made to design computer pointing devices that allow zero fatigue/zero-reaching-distance operation. One solution to these problems is to integrate the functions of a computer mouse with the individual user's hand. Prior Art FIG. 1 shows an attempt to do this. It is described in U.S. Pat. No. 6,097,369 issued to Wambach on Aug. 1, 2000. Wambach describes a glove to be worn on a user's hand wherein the glove includes micro-switches mounted next to a joint of the index finger and on opposite sides of the wrist. The switches translate up and down movement of the index finger and side to side movement of the wrist into vertical and horizontal movements, respectively, of a cursor on a computer display. Buttons are provided on the other fingers to provide mouse clicking functions and to turn the glove on and off. These buttons are activated by the thumb. Although the device described by Wambach makes the mouse and hand to be zero reaching distance, it can not actuate the movement of “hold-drag” and “highlight” by the same hand, as the thumb actuation can only touch one point at a time. Further, the device must be manually activated prior to use and manually deactivated after use so that hand movements are not inadvertently translated into cursor movements on the screen while the fingers are for other use, such as typing. Another attempt at a solution is described in U.S. Pat. No. 6,724,366 shown in Prior Art FIG. 2 issued to Crawford on Apr. 20, 2004. Crawford describes an input device for a computer comprising a touchpad positioned perpendicular to the thumb such that the user provides input with the thumb tip by using pivotal movement of the thumb. Various stress-reducing zero force touch switches are disclosed including zero force touch switches that can be adjusted to accommodate variations in user finger length. The mode of touchpad can be altered through the use of touchpad perimeter inputs. Although this invention has paid attention to its hand ergonomic effects and zero-force mouse operation, yet the device is not of zero reaching distance. Further, the perpendicular orientation of the touch pad makes it cumbersome for the user with longer thumb nails to touch the pad. Another hand attached mouse device is described in U.S. Pat. No. 6,850,224 shown in Prior Art FIG. 3 issued to Baughman on Feb. 1, 2005. The invention is designed to be worn on the hand of a computer user for use in conjunction with various types of computer systems. A base attaches to the user's hand through the use of flexible adjustment straps. The base houses the electronic and/or computer circuitry needed for developing and transmitting electrical signals to the user's computer system, the signals corresponding to the signals on a conventional mouse. Although this device allows the user to be of zero reaching distance in operation, yet it is cumbersome when the user feels like to be engaged to other tasks such as typing. Still another hand attached mouse is described in U.S. Pat. No. 6,870,526 shown in Prior Art FIG. 4 issued to Zngf, et al. on Mar. 22, 2005. A glove-like apparatus mounted on a user's hand to control the cursor movement and to click for providing functions of a computer mouse. The apparatus has a glove-like body with multiple finger tubes. A tilt sensor is mounted on the glove metacarpus, of which the roll angle of the hand is detected to determine the moving orientation of the cursor. Two pairs of bending sensors are mounted on the thumb tube and the index finger tube, each pair of the sensors is used to detect a bending angle of the corresponding finger. The bending of the thumb or the index finger at a time is used to move the cursor in the negative or the positive direction along the located orientation line. The data glove for cursor control is operated as a virtual mouse with a virtual tracking ball. Although this device can realize the ability of zero-reaching-distance, yet it will make the user's hand get fatigue for a long time mouse operation. Still another design is described in U.S. Pat. No. 7,057,604 shown in Prior Art FIG. 5 issued to Bajramovic on Jun. 6, 2006. The computer input device on a glove includes fittings for a user's fingers and adjustable straps for fastening to a user's wrist. A tracking device for controlling cursor movement on a video display is affixed to the glove for positioning next to the end of one of the user's fingers. Pressure plates for controlling the various right and left mouse “clicking” functions are affixed to the glove for positioning next to the ends of the other of the user's fingers. Scrolling/paging buttons are located on the side of the fitting fitted to the index finger for pressing by the thumb. A transmitter is affixed to the glove for receiving signals from the tracking device, the pressure plates and the scrolling/paging buttons, and transmitting those signals to a computer for controlling cursor movement in the x-y plane on a video display and for controlling the various mouse “clicking” controls, which implement the “select” function, the “drag” function, the “scroll” function, the “page” function, and so forth. This design, however, requires the user to fix the finger on a flat surface and the user has to reach a distance for the mouse operation. Further, the design will obstruct the user's fingers from other tasks such as typing, as the mouse buttons and cursor actuation parts cover the user's fingers, which will not allow the user of longer nails to type or carry out any other tasks.

While the aforementioned mice configurations may be suitable for most occasional computer users, there remain inadequacies for the use of computer mice in creating an environment of relaxing the user upper body muscle groups for regular and repeated computer users. The required positioning of the traditional computer mouse is that of reaching forward to the desktop or tabletop in front of the user. This positioning causes the user arm muscle groups, shoulder muscle groups and neck muscle groups to be engaged during periods of computer use.

Accordingly, it is a general object of the invention to provide a touch pad mouse with a palm attached base to realize the nature of zero force and zero reaching distance that gives the user freedom of arm movement position when engaged in computer usage of the mouse function.

It is another object of the invention to provide a computer mouse which allows the user an environment most ergonomically correct to human physiological function which allows more relaxation of the upper body small muscle groups during use over conventional computer mouse devices.

It is another object of the invention to provide a ball joint assembly attached to the mouse which allows the user to adjust positioning up and down in the palm for larger and smaller hand use respectively, adjust the touch pad mouse in multi-direction for individual preference when in use. This 360 degree capability will give the user the capability to direct the touch-pad back to clear the palm when the user wishes to type on the computer keyboard and then back to the use position when mouse operations are demanded.

It is another object of the invention to provide the user the capability of rotating the touch-pad in the hand 180 degrees and by this positioning, shifts the use of the key-pad from the thumb guided operation to the index or middle finger.

### SUMMARY OF THE INVENTION

The above recited objects of the invention and others which will become apparent upon a reading of the following specification and claims are achieved by the present invention which provides for a palm attached touch-pad which attaches to the user palm, regardless where the hand is located during operation of this device. When not in use, the palm attached touch-pad may be pivoted out of the finger position so that the user may utilize the keyboard for required keyboard input to the computer or any other work that requires the finger operation of the user, such as writing.

### DESCRIPTION OF THE DRAWINGS

The invention may be described with great clarity and particularity by reference to the accompanying drawings in which like reference numerals are used to indicate like parts in the various views.

FIG. 1a is a perspective view of the touch-pad frontal view and FIG. 1b is a perspective view of the touch-pad side view.

FIG. 2a is a perspective view of the palm attachment top view, FIG. 2b is a perspective view of the palm attachment side view and FIG. 2c is a perspective view of the palm attachment bottom view.

FIG. 3a is a cross-section view, showing the pivotal movement of the touch-pad moving side to side, FIG. 3b showing the movement of the touch-pad moving up and down for adjustment to large/small hands respectively, FIG. 3c showing the side view in an upright 90 degree position to the palm, FIG. 3d showing the touch-pad in a position of being against the heel of the palm when keyboard activity is needed and FIG. 3e showing the touch-pad adjustment movement for input use.

FIG. 4a shows the palm attached touch-pad in use with the thumb moving on the touch-pad, the right index finger on top of the touch-pad, controlling the traditional right click button and the middle finger controlling the traditional left click function button. FIG. 4b shows the palm-attached touch-pad with the hand in the open position. FIG. 4c shows the palm attached touch-pad against the heel of the hand which has been flipped back, out of the palm to enable the user to use the computer keyboard.

### DETAILED DESCRIPTION OF THE INVENTION

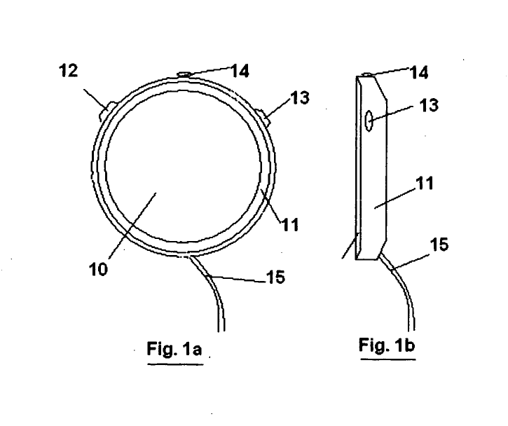

Referring now to the drawings in more detail, the touch-pad 10 is inserted into the touch-pad housing 11 and illustrated with a right side soft key 13, a left side soft key 12 and a top side soft key 14, the keys function as the left and right buttons of the traditional mouse. In FIG. 1 also contains the view of the attached wiring which is further attached to the mouse controller slot on traditional computers for input capabilities.

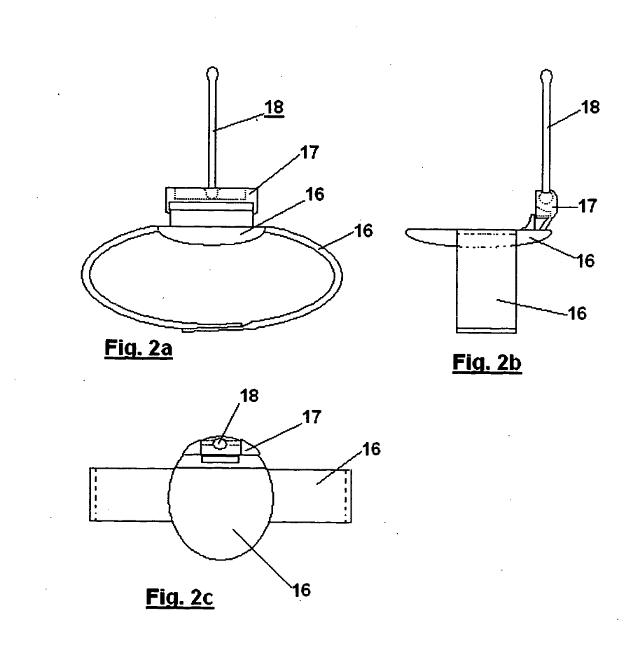

FIG. 2a is a cross-section view of the touch-pad palm attached base, showing a stainless steel post 18 to attach the touch-pad palm attached base to the touch-pad. Also shown is the snap-close joint 17 and the durable plastic strip 16 to which the snap-close joint 17 is attached, forming the touch-pad palm attached base. FIG. 2b shows the side view of the touch-pad palm attached base and FIG. 2c shows the upper view of the touch-pad palm attached base.

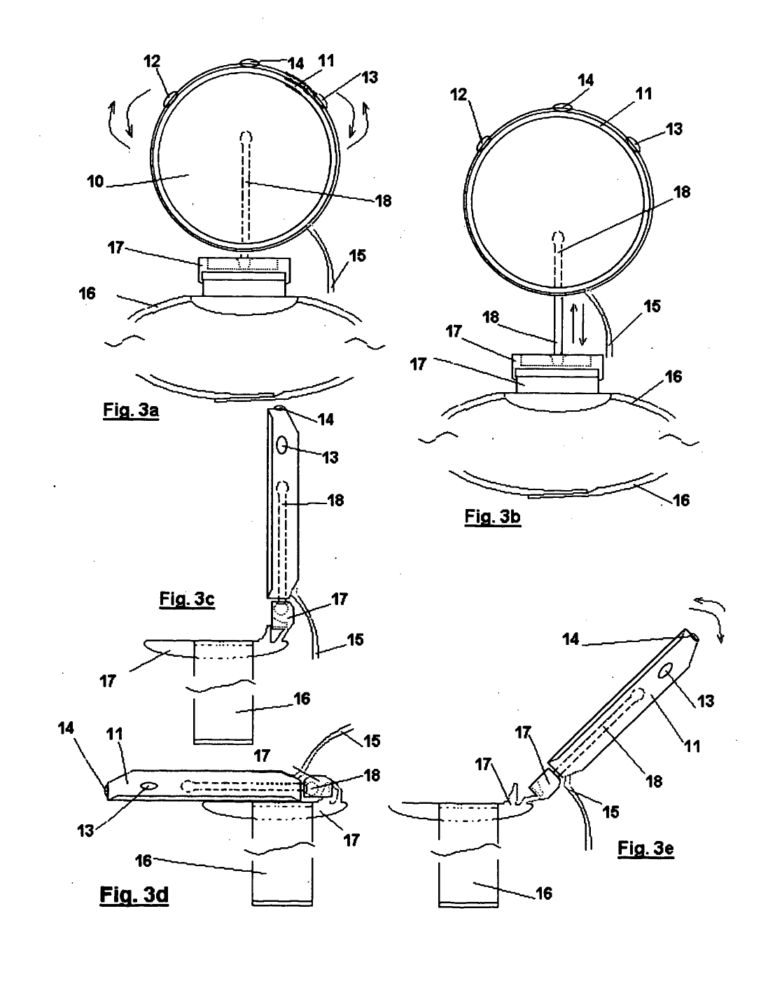

FIG. 3a is a fragmentary front view of the palm attached touch-pad and base integrated together, showing the stainless steel post 18 inserted into the touch-pad 10 with the right side soft touch button 13, the left side soft touch button 12, the top soft touch button 14, the touch-pad attached base 11, the snap-close joint 17, the control attached wiring 15 and the palm attached durable plastic strip 16. Inserted arrows to the 3a view shows the side movement of the touch-pad which is enabled due to the stainless steel post 18 which is inserted into the snap close joint 17. FIG. 3b is a fragmentary end view of the palm attached touch-pad 10 and base 16 and 17, attached together, showing the same operations as FIG. 3a with the exception of the up and down arrows shown showing the height adjustment in an upright position for a larger hand. This is the hand-size adjustment. FIG. 3c is a fragmentary side view of the said objects shown in FIGS. 3a and 3b. FIG. 3d is the same side view as in FIG. 3c with the exception showing the touch-pad 10, 11 in the back position parallel with the wrist to enable the user to type on the computer keyboard. FIG. 3e is a fragmentary side view as in FIGS. 3c and 3d with the exception showing the touch-pad 10, 11 being adjusted front and back in the palm for the users' adjustment need for comfort of operations.

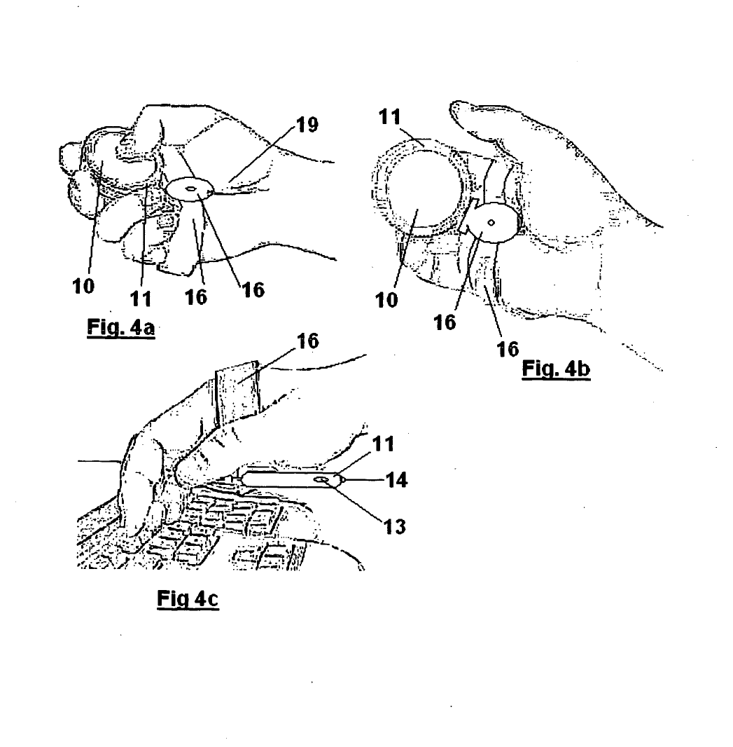

FIG. 4a illustrates a view of a right hand 19 user with the palm attached touch-pad 10, 11 fully attached to the base 16 in the operating position. FIG. 4b is a view of the same right hand use only with the thumb, index finger and middle finger removed from the device. FIG. 4c is a view of the same configuration as FIGS. 4a and 4b with the exception that the touch-pad 10, 11 is in the back position against the right hand 19 showing the right hand operating the computer keyboard while the palm attached touch-pad is intact with the right hand 19.

It will be understood that there are numerous methods that may be utilized to provide palm attached mounting brackets which attach to the connecting stainless steel post of the palm attached touch-pad mouse to pivotably attach the touch-pad and similarly there are many alternatives for the snap-close joint which attaches and engages the stainless steel post to the touch-pad which allows for a 360 degree rotational movement of the touch-pad and the up and down adjustment for hand size.

Although preferred embodiments of the present invention have been disclosed in detail herein, it will be understood that various substitutions and modifications may be made to the disclosed embodiment described herein without departing from the scope and spirit of the present invention as recited in the appended claims.

I claim:

1. A palm attached touch-pad computer mouse for use with various computers having the same capabilities of operations as a mouse of conventional computer configuration comprising:
(a) a palm attached base for the touch-pad;
(b) a touch-pad inserted into the palm attached base for input to the computer;

2. Right and left function/identical soft keys to allow the user of either right or left hand case to operate, in the same hand, the mouse function of left/right click and drag function of the traditional computer mouse.

3. Touch-pad palm attachment base consisting of a durable plastic strip and ergonomic shaped base, complete with plastic snap close joint to the stainless steel ball joint from the touch-pad described in claim 1.

4. The inside of the touch-pad housing contains a female rubber housing to accommodate the opposing end of the stainless post; the other end of the stainless steel ball described in claim 3.

5. The ball joint described in claim 3 and 4 contain a stainless steel post which allows the touch-pad to rotate left and right and also to rotate 360 degrees circularly in the palm. The rotation also allows the touch-pad to rotate side-to-side to enable adjustment to the user's hand. Also this ball joint allows the touch-pad to be flipped with a finger motion to relocate the touch-pad to be horizontal to the wrist to be removed from the fingers which allows the user to simultaneously use the keyboard and/or writing with pen or pencil since the touch-pad will not inhibit these activities.

6. The ball joint of the touch-pad allows the user to rotate the touch-pad 180 degrees to turn the touch-pad to face the user's fingers that allow the user to use the touch-pad with the index finger for mouse movement operation to relieve repetitive motion from the thumb to index or middle finger at will. With the unique capabilities of the right and left soft touch buttons being the same computer function, both right and left hand users and in this case, upside down use is the same computer input function.
